(19) United States
(12) Patent Application Publication
(10) Pub. No.: US 2010/0133962 A1
(43) Pub. Date: Jun. 3, 2010

(54) SHAFT-HUB CONNECTION BETWEEN A BELT PULLEY AND A GENERATOR SHAFT AS WELL AS BELT-DRIVEN STARTER GENERATOR WITH SUCH A SHAFT-HUB CONNECTION

(75) Inventors: Bernd Hartmann, Weisendorf (DE); Roland Arneth, Eggolsheim (DE); Christian Hauck, Altdorf (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: Schaeffler KG, Herzogenaurach (DE)

(21) Appl. No.: 12/627,490

(22) Filed: Nov. 30, 2009

(30) Foreign Application Priority Data
Nov. 28, 2008 (DE) 102008059572.1

(51) Int. Cl. H02K 7/10; F16D 1/06

(52) U.S. Cl. 310/75 R; 403/320

(57) ABSTRACT

A shaft-hub connection (10) between a belt pulley (14) and a shaft (16), in particular, between a belt pulley and the generator shaft of a belt-driven starter generator, wherein the belt pulley (14) has a decoupler shaft (12) and the generator shaft (16) has a coaxial thread (20) that is connected to the decoupler shaft (12) for transmitting torque. The connection between the decoupler shaft (12) and the thread (20) of the generator shaft (16) is secured against loosening. In addition, a belt-driven starter generator with such a shaft-hub connection is provided.

### CROSS-REFERENCE TO RELATED APPLICATIONS

This application claims the benefit of German Patent Application No. DE 10 2008 059 572.1, filed Nov. 28, 2008, which is incorporated herein by reference as if fully set forth.

### BACKGROUND

The invention relates to a shaft-hub connection between a belt pulley and a generator shaft, in particular, between a belt pulley and the generator shaft of a belt-driven starter generator, wherein the belt pulley has a decoupler shaft and the generator shaft has a coaxial threading that is connected to the decoupler shaft for transmitting torque. In addition, the invention relates to a belt-driven starter generator with such a shaft-hub connection between the belt pulley and the generator shaft.

For a fairly long time, motor vehicles have been equipped with a so-called start/stop function in which the combustion engine is shut down, for example, when stopped at a traffic light and when the engine is merely idling, and restarted after the gas pedal is activated. For starting the engine, a so-called starter generator is used that involves a functional unit formed from a starter motor and a generator, wherein this unit is coupled with the combustion engine via a conventional belt. Such a belt-driven starter generator is disclosed, for example, in WO 2007/121582 A1.

To be able to use the starter generators for a wide array of different vehicle types, all common starter generators that are currently available are equipped with a generator shaft that has a standard right-handed threading on which the decoupler shaft of a belt pulley is screwed. If the combustion engine is now started by the starter generator, this screw connection is loaded in the loosening rotational direction between the decoupler shaft and the generator shaft. Due to the impact-like loading by the high torque produced during the starting of the engine, frequent starting of the combustion engine could lead to a loosening of the screw connection between the decoupler shaft and the generator shaft, which could have fatal consequences.

### SUMMARY

Starting with the state of the art noted above, the objective of the invention is to provide a shaft-hub connection that prevents loosening of the decoupler shaft for the use of belt-driven starter generators with threaded generator shafts.

According to the invention, this objective is met by a shaft-hub connection with the features of the invention. Preferably, the connection between the decoupler shaft and the threading of the generator shaft is secured against loosening. A belt-driven starter generator is also provided according to the invention.

According to the invention, the decoupler shaft is connected to the threading of the generator shaft for transmitting torque, wherein the connection between the decoupler shaft and the threading of the generator shaft is simultaneously secured against unintentional loosening caused by, in particular, impact-like torque loading during the starting of the combustion engine.

According to the invention, problems appearing in conventional belt-driven starter generators in which the generator shafts are provided with threading for coupling with the decoupler shaft can be effectively prevented in a simple way.

Additional advantages of the invention emerge from the following description and the drawing, as well as from the subordinate claims.

For example, in the case of an especially preferred embodiment of the shaft-hub connection according to the invention, the decoupler shaft is also provided with a thread that extends coaxial to the rotational axis of the decoupler shaft and that engages with the thread of the generator shaft. For securing against unintentional loosening, the screw connection is joined between the decoupler shaft and the generator shaft. For joining, the threads are connected rigidly to each other, for example, through welding or hard soldering at the transition of the decoupler shaft to the generator shaft. Alternatively or additionally, the threads could also be secured against loosening by adhesion, wherein, as a securing material, the adhesion provides the advantage that, through corresponding heating, the adhered connection could also be optionally loosened.

Furthermore, loosening could also be prevented by providing a friction-fit connection between the decoupler shaft and the generator shaft. For example, in the case of an especially preferred embodiment, a friction element with a lateral surface that is formed as a friction surface and that tapers toward the free end is to be screwed onto the thread of the generator shaft formed as an external thread. In contrast, the decoupler shaft is provided with a conical seat that is placed on the conical lateral surface of the friction element and that is clamped to this surface. In order to prevent loosening of the friction element screwed onto the thread of the generator shaft, the friction element could be secured, on its side, for example, by joining to the generator shaft.

Alternatively, in the case of an embodiment in which a friction-fit connection is provided between the decoupler shaft and the generator shaft, it is proposed to provide, on the decoupler shaft, a thread that extends coaxial to its rotational axis and that is screwed with the thread of the generator shaft, wherein, on the decoupler shaft and the generator shaft, a step is formed on each of these shafts and the end faces of these steps are arranged directly opposite each other and contact each other with the formation of a friction-fit connection under biasing. Advantageously, for increasing the friction between the two steps, teeth, a flange, a friction coating, or also a diamond film is provided at least in some areas on at least one of the two end faces of the steps for increasing the friction between the two steps.

In addition, in another embodiment it is provided to secure the shaft-hub connection between the two shafts by a positive-fit connection. For example, in the case of a preferred refinement of this embodiment, it is proposed to screw a bushing with a feather key groove on the thread of the generator shaft formed as an external thread, while, on the decoupler shaft, a receptacle with a feather key groove is formed and, for transmitting torque, a feather key is inserted into the two feather key grooves.

Alternatively, it is also possible, for forming a positive-fit connection, to equip the decoupler shaft with a thread running coaxial to its rotational axis and to screw this thread with the thread of the generator shaft, wherein the screw connection between the decoupler shaft and the generator shaft is secured against loosening by pins. For this purpose, for example, a transverse borehole extending through the decoupler shaft and the generator shaft is formed in which, for example, an alignment pin or a bolt is inserted for pinning.

According to a second aspect, the invention relates to a belt-driven starter generator in which the generator shaft is coupled with the decoupler shaft of the belt pulley by a shaft-hub connection according to the invention for transmitting torque.

### BRIEF DESCRIPTION OF THE DRAWINGS

Below, the invention will be explained in greater detail using several embodiments with reference to the accompanying drawing. Shown therein are:

FIG. 1 is a partially sectioned side view of a shaft-hub connection secured against loosening by welding between a decoupler shaft of a belt pulley and a generator shaft of a starter generator,

FIG. 2 is an enlarged diagram of the engaged threads of a decoupler shaft and a generator shaft that are secured against loosening by adhesion,

FIG. 3 is a side view of a generator shaft of a starter generator on whose external thread a conical friction element is screwed for the detachable connection to a decoupler shaft of a belt pulley,

FIG. 4 is a side view of a generator shaft of a starter generator on whose external thread a bushing with a feather key groove is screwed for the detachable connection to a decoupler shaft of a belt pulley,

FIG. 5 is a side view of a decoupler shaft of a belt pulley screwed on the external thread of the generator shaft, wherein, for securing against loosening of the screw connection between the end face of the decoupler shaft and a step of the generator shaft, a friction coating is arranged for forming a friction-fit connection, and

FIG. 6 is a side view of a decoupler shaft of a belt pulley screwed on the external thread of the generator shaft, wherein the screw connection is pinned for securing against loosening.

### DETAILED DESCRIPTION OF THE PREFERRED EMBODIMENTS

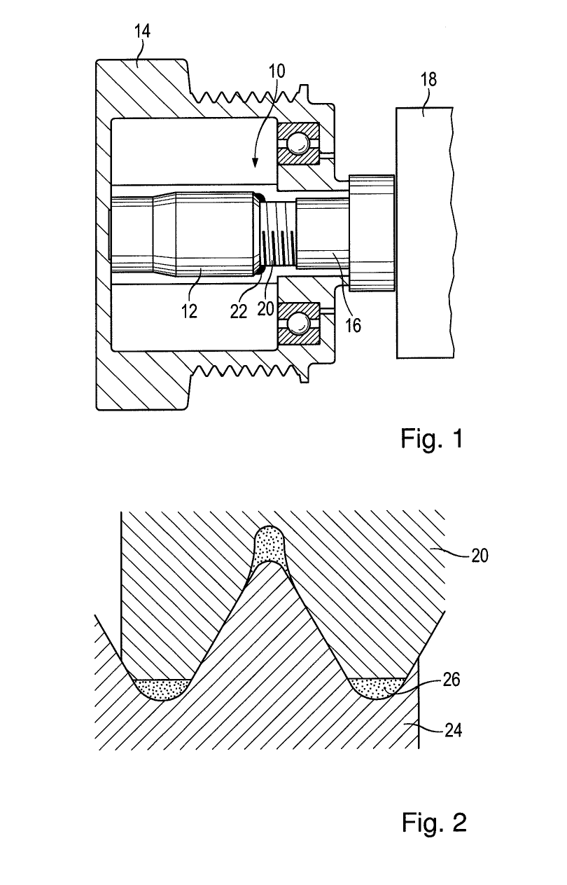

In FIG. 1, a partially sectioned side view of a shaft-hub connection 10 according to the invention between a decoupler shaft 12 of a belt pulley 14 and a generator shaft 16 of a starter generator 18 is shown.

The generator shaft 16 of the starter generator 18 is provided with an external thread 20, while the decoupler shaft 12 is provided with an internal thread not shown in FIG. 1 with which the decoupler shaft 12 is screwed on the external thread 20 of the generator shaft 16. To prevent unintentional loosening of the shaft-hub connection 10, the decoupler shaft 12 is connected rigidly on its end face to the external thread 20 of the generator shaft 16 according to the invention by joining, in the present case, by welding. Through the welded connection 22 between the decoupler shaft 12 and the generator shaft 16, unintentional loosening, as could occur due to impact-like loading when the starter generator is started, is effectively prevented.

In FIG. 2, in an enlarged diagram, a modified embodiment of the shaft-hub connection 10 according to the invention is shown in which the internal thread 24 of the decoupler shaft 12 is connected rigidly through adhesion to the external thread 20 of the generator shaft 16, without the decoupler shaft 12 being welded with the generator shaft 16. Here, the internal thread 26 has, at least in some areas, openings that are larger than conventional internal threads, in order to create sufficient space for the adhesive (adhesive reservoir). One essential advantage in this securing against loosening by the adhered connection 26 between the two threads 20 and 24 is that the adhered connection 26 can be loosened again, if necessary, through heating.

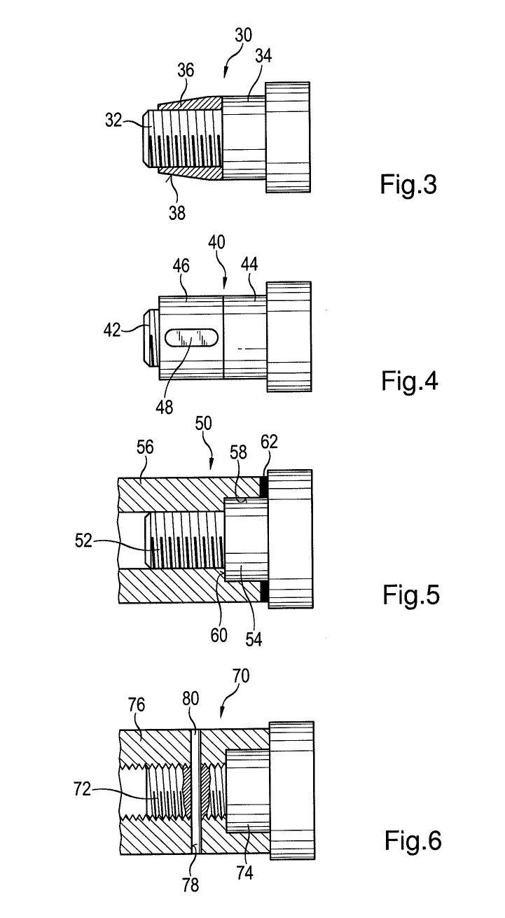

In FIG. 3, a second embodiment of a shaft-hub connection 30 according to the invention is shown in which a friction element 36 is screwed on the external thread 32 of the generator shaft 34 and is connected rigidly to the external thread 32 by adhesion. The friction element 36 has a hollow cone construction, wherein the lateral surface 38 tapers in the direction of the free end of the external thread 32 and thus forms a conical surface. For fixing the decoupler shaft (not shown), the decoupler shaft is formed with a conical seat with which the decoupler shaft is clamped on the lateral surface 38 of the friction element 36.

FIG. 4 shows a third embodiment of a shaft-hub connection 40 according to the invention in which a bushing 46 with a feather key groove 48 is screwed on the external thread 42 of the generator shaft 44 and is locked in rotation with the generator shaft 44 through adhesion. For the detachable connection of the decoupler shaft (not shown), a receptacle with a feather key groove is formed on the decoupler shaft with which the decoupler shaft is pushed on the bushing 46, wherein, for transmitting the torque, a feather key (not shown) is inserted into the two feather key grooves 48.

FIG. 5 shows a fourth embodiment of a shaft-hub connection 50 according to the invention in which the decoupler shaft 56 is screwed on the external thread 52 of the generator shaft 54, wherein the decoupler shaft 56 has, on its free end, a centering adapter 58 of larger diameter with which the decoupler shaft 56 is pushed onto a first step 60 formed on the generator shaft 54. On the end face of the centering adapter 58, a friction coating 62 is affixed that contacts the end face of a second step 64 of the generator shaft 54 under biasing when the decoupler shaft 56 is properly screwed. Here, by the friction coating 62 between the generator shaft 54 and the decoupler shaft 56, a friction-fit connection is formed that prevents loosening of the screw connection in the case of impact-like torque loading in the loosening rotational direction.

In FIG. 6, a fifth embodiment of a shaft-hub connection 70 according to the invention is shown in which the decoupler shaft 76 is screwed on the external thread 72 of the generator shaft 74. Transverse to the rotational axis of the shafts 74 and 76, a passage borehole 78 that intersects the rotational axis of the shafts 74 and 76 and in which an alignment pin 80 is inserted runs through the generator shaft 74 and the decoupler shaft 76. The alignment pin 80 is here used as a securing device against unintentional loosening of the screw connection between the two shafts 74 and 76 in the case of impact-like torque loading in the loosening rotational direction.

The previously described embodiments show only a few of the possible solutions. Different solutions could also be combined with each other. For example, the adhered connection 26 could be secured by additional pins. It is also possible to additionally secure the two shafts 54 and 56 screwed to each other by adhesion or pinning in the embodiment shown in FIG. 5.

### REFERENCE SYMBOLS

10 Shaft-hub connection

12 Decoupler shaft

14 Belt pulley

16 Generator shaft

18 Starter generator

20 External thread

22 Welded connection

24 Internal thread

26 Adhered connection

30 Shaft-hub connection

32 External thread

34 Generator shaft

36 Friction element

38 Lateral surface

40 Shaft-hub connection

42 External thread

44 Generator shaft

46 Bushing

48 Feather key groove

50 Shaft-hub connection

52 External thread

54 Generator shaft

56 Decoupler shaft

58 Centering adapter

60 First step

62 Friction coating

64 Second step

70 Shaft-hub connection

72 External thread

74 Generator shaft

76 Decoupler shaft

78 Passage borehole

80 Alignment pin

1. Shaft-hub connection between a belt pulley and a generator shaft, comprising the belt pulley including a decoupler shaft and the generator shaft having a coaxial thread that is connected to the decoupler shaft for transmitting torque, the connection between the decoupler shaft and the thread of the generator shaft is secured against loosening.

2. Shaft-hub connection according to claim 1, wherein the decoupler shaft has a coaxial thread that is screwed onto the thread of the generator shaft and the screw connection is secured against loosening by joining, advantageously by at least one of welding, hard soldering, or adhesion.

3. Shaft-hub connection according to claim 2, wherein the decoupler shaft and the generator shaft are welded or hard soldered at a transition of the engaged threads.

4. Shaft-hub connection according to claim 2, wherein the engaged threads are adhered to each other.

5. Shaft-hub connection according to claim 1, wherein the connected shafts for transmitting torque are secured against loosening by a friction-fit connection between the decoupler shaft and the generator shaft.

6. Shaft-hub connection according to claim 5, wherein a friction element with a lateral surface that tapers like a cone toward a free end and that is formed as a friction surface is screwed on the external thread of the generator shaft and the lateral surface is clamped at least in some areas in a conical seat formed on the decoupler shaft.

7. Shaft-hub connection according to claim 5, wherein the decoupler shaft has a coaxial thread that is screwed onto the thread of the generator shaft and a step is formed on each of the decoupler shaft and the generator shaft, and end faces of each of the steps are arranged directly opposite each other and contact each other with a friction-fit connection under biasing.

8. Shaft-hub connection according to claim 7, wherein teeth or a friction coating are provided on the end face of at least one of the two steps for increasing the friction.

9. Shaft-hub connection according to claim 1, wherein the connection between the two shafts is secured against loosening by a positive-fit connection.

10. Shaft-hub connection according to claim 9, wherein a bushing with a feather key groove is screwed on the external thread of the generator shaft and is secured against loosening, a receptacle with a feather key groove is formed on the decoupler shaft, and the generator shaft is inserted with the bushing provided on it into the receptacle of the decoupler shaft, and a feather key is inserted into the two feather key grooves for transmitting torque.

11. Shaft-hub connection according to claim 9, wherein the decoupler shaft has a coaxial thread that is screwed onto the thread of the generator shaft and the screw connection between the decoupler shaft and the generator shaft is secured against loosening by a pin.

12. Shaft-hub connection according to claim 1, wherein the belt pulley and the generator shaft are part of a belt-driven starter generator.

13. Belt-driven starter generator with a generator shaft and decoupler shaft of a belt pulley coupled with a thread provided on the generator shaft for transmitting torque, the decoupler shaft is coupled by a shaft-hub connection with the generator shaft.
